(19) United States
(12) Patent Application Publication
(10) Pub. No.: US 2005/0249414 A1
(43) Pub. Date: Nov. 10, 2005

(54) Knowledge discovery device, knowledge discovery method, and computer product

(75) Inventors: Yusuke Uehara, Kawasaki (JP); Daiki Masumoto, Kawasaki (JP); Shuichi Shiitani, Kawasaki (JP); Susumu Endo, Kawasaki (JP); Takayuki Baba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/182,808

(22) Filed: Jul. 18, 2005

Related U.S. Application Data
(63) Continuation of application No. PCT/JP03/04830, filed on Apr. 16, 2003.

(51) Int. Cl. G06K 9/00; G06N 5/04

(52) U.S. Cl. 382/181; 706/61

(57) ABSTRACT

A knowledge discovery device analyzes a relation between a feature value of an image and attribute data, and discovers a knowledge on the relation. The knowledge discovery device includes a feature-value extraction unit that extracts, as a feature value, each degree of changes in luminance of frequency components at each position on the image, from image data, a relation analysis unit that analyzes a relation between the feature value and attribute data, and a rule generation unit that generates an association rule using content of the feature value having a correlation value not more than a predetermined correlation value and content of the attribute data.

### BACKGROUND OF THE INVENTION

1) Field of the Invention

The present invention relates to a technology for discovering knowledge on a relation between a feature value of an image and attribute data.

2) Description of the Related Art

In recent years, images are used for applications such as design and inspection in a manufacturing industry and marketing in a retail trade. For example, in inspection in a manufacturing industry, images are used to find out a failure occurrence rate. In this application, a metal part of a machine during operation is periodically photographed. When a failure occurs in the machine, an image obtained by photographing the metal part a predetermined time prior to occurrence of the failure is examined to check color and a crack on the surface whether there is a color change in a particular color of a certain location or whether there is any crack in a certain location. Thus, the failure occurrence rate for each case is discovered. In the marketing of retail trade, images are used in a space management. In this application, shelf allocation of items is photographed at a retail store such as a convenience store. A relation between an image and numerical data related to sales of the items is analyzed to find an effective shelf allocation to improve sales.

Conventionally, such processes are performed manually. To discover a relation between a feature and a position of a local area on the image and the attribute data, analysis of the image to find a relation with attribute data on the failure occurrence rate or the sales is performed by a person. Therefore, a great deal of labor is required. On the other hand, another technique has been proposed. This technique is such that a computer automatically calculates a relation between the feature and the position of the local area on the image and the attribute data.

This technique is aimed at discovering an activated portion of a brain corresponding to a particular action of a human. The brain reacting in response to an action of the human is scanned using Functional Magnetic Resonance Imaging (f-MRI) to obtain a data group of tomographic images of the brain at that time. By using the data group, a position in an active state of the brain is analyzed based on each tomographic image obtained by laterally and longitudinally dividing an image to automatically discover a location of the brain corresponding to the action.

Such technologies are disclosed in, for example, M, Kakimoto, C. Morita, and H. Tsukimoto: Data Mining from Functional Brain Images, In Proc. of ACM MDM/KDD2000, pp. 91-97 (2000).

The technique, however, targets binary data, as the attribute data, indicating whether a particular action is carried out. Therefore, if it is necessary to analyze a distribution pattern of pixel values of an area in a particular position of image data, this technique is not applicable to, for example, prediction of occurrence of a failure in a metal part of a machine.

Moreover, in the technique, an image is divided into images of a predetermined size, the analysis is performed per each of the images obtained through division. Therefore, the technique is not applicable to a case in which the size of an area is not previously determined. If the sizes of areas related to the attribute data are different from one another depending on cases as in the analysis on an image of shelf allocation, it is impossible to use this technique.

### SUMMARY OF THE INVENTION

It is an object of the present invention to solve at least the problems in the conventional technology.

A knowledge discovery device according to one aspect of the present invention analyzes a relation between a feature value in an image and attribute data using a plurality of pairs of image data and attribute data that is correlated to the image data, and discovers a knowledge on the relation. The knowledge discovery device includes a feature-value extraction unit that generates multiple-resolution image data from each of the image data, and that extracts a feature value from the multiple-resolution image data; and a relation analysis unit that analyzes a relation between the feature value and the attribute data.

A knowledge discovery method for analyzing a relation between a feature value in an image and attribute data using a plurality of pairs of image data and attribute data that is correlated to the image data, and for discovering a knowledge on the relation according to another aspect of the present invention includes generating multiple-resolution image data from each of the image data; extracting a feature value from the multiple-resolution image data; and analyzing a relation between the feature value and the attribute data.

A computer-readable recording medium according to still another aspect of the present invention stores a computer program for realizing a knowledge discovery method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a knowledge discovery device according to a first embodiment of the present invention;

FIG. 2 is a table of image data stored in an image-data storage unit;

FIG. 3 is a table of attribute data stored in an attribute-data storage unit;

FIG. 4 is a schematic of to multiple resolution processing performed on image data by a feature-value extraction unit;

FIG. 5 is a schematic of wavelet transform performed on image data;

FIG. 6 is a schematic of a display of a result of the wavelet transform;

FIG. 7 is a flowchart of a process of the knowledge discovery device according to the first embodiment;

FIG. 8 is a schematic of an image obtained by photographing a surface of a metal part of a machine;

FIG. 9 is a schematic of a display for a knowledge discovered by the knowledge discovery device from the image shown in FIG. 8;

FIG. 10 is a block diagram of a knowledge discovery device according to a second embodiment of the present invention;

FIG. 11 is a schematic of multiple resolution processing performed on image data by a feature-value extraction unit shown in FIG. 10;

FIG. 12 is a schematic of a display for a knowledge discovered by the knowledge discovery device according to the second embodiment;

FIG. 13 is a schematic of a computer system fro executing a knowledge discovery program according to the first embodiment and the second embodiment; and

FIG. 14 is a block diagram of a main body shown in FIG. 13.

### DETAILED DESCRIPTION

Exemplary embodiments of the present invention are explained in detail below with reference to the accompanying drawings. It is noted that a case where the knowledge discovery device according to the present invention is used for predicting occurrence of a failure in a metal part of a machine is explained in a first embodiment of the present invention, and that a case where the knowledge discovery device according to the present invention is used for shelf allocation at retail stores is explained in a second embodiment of the present invention.

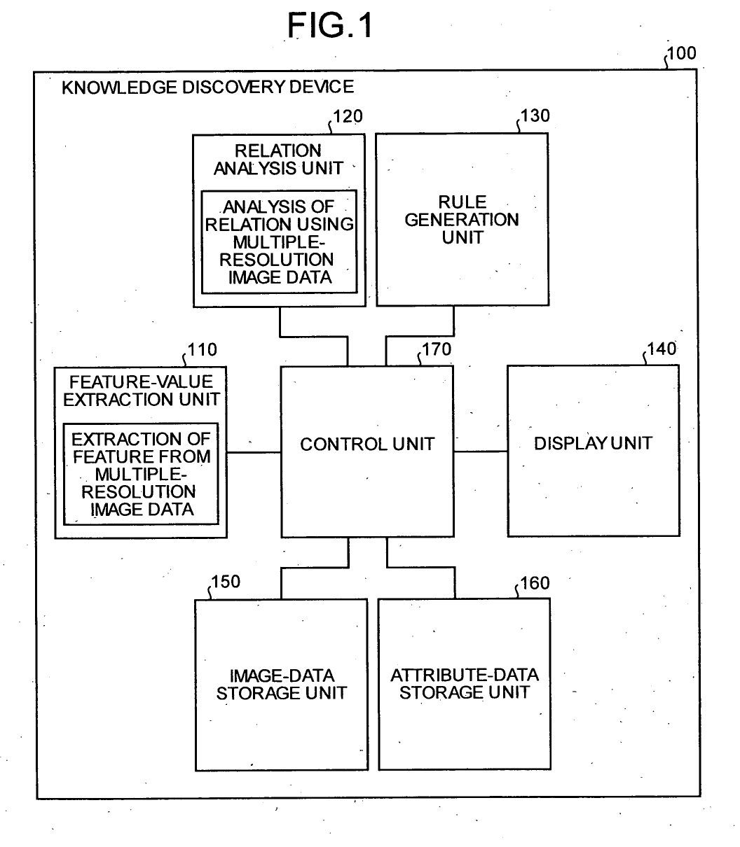

FIG. 1 is a block diagram of a knowledge discovery device according to the first embodiment. A knowledge discovery device 100 includes a feature-value extraction unit 110, a relation analysis unit 120, a rule generation unit 130, a display unit 140, an image-data storage unit 150, an attribute-data storage unit 160, and a control unit 170.

The feature-value extraction unit 110 subjects the image data stored in the image-data storage unit 150, to multiple resolution, and extracts a feature value from the image data subjected to multiple resolution (or multiple-resolution image data). More specifically, the feature-value extraction unit 110 subjects the image data for a metal part stored in the image-data storage unit 150 to wavelet transform, and extracts, as a feature value, each degree of changes in luminance in longitudinal, lateral, and oblique directions of a plurality of frequency components at positions on the image, from the image data.

The relation analysis unit 120 analyzes a relation between a feature value and attribute data by using the feature value extracted from the multiple-resolution image data by the feature-value extraction unit 110 and the attribute data stored in the attribute-data storage unit 160. More specifically, the relation analysis unit 120 calculates a correlation value between each degree of changes in luminance longitudinal, lateral, and oblique directions of the frequency components at positions on the image, as feature values, and an elapsed time until a failure occurs, as attribute data. And then, the relation analysis unit 120 analyzes a relation between the feature value and the attribute data. Details of the processes in the feature-value extraction unit 110 and the relation analysis unit 120 are explained later.

The rule generation unit 130 generates a knowledge on a relation between the feature value and the attribute data based on the result of analysis by the relation analysis unit 120. More specifically, the rule generation unit 130 generates an association rule in which the content of the feature value is set as a condition part and the content of the attribute data is set as a conclusion part.

For example, the rule generation unit 130 generates an association rule as follows. Specifically, if a large value, which indicates a high degree of a change in luminance in a lateral direction in a high-frequency, appears in an upper right part of the image, it indicates that a failure occurs in a short time. In other words, there is a high possibility of occurrence of a failure in a machine within a short period of time if cracks like fine vertical stripes appear in an upper right part on the surface of a metal part of the machine.

Although generating the association rule with the content of the feature value as the condition part and the content of the attribute data as the conclusion part herein, the rule generation unit 130 can also generate an association rule in which the content of the attribute data is set as a condition part and the content of the feature value is set as a conclusion part.

The display unit 140 visually displays a position on the image where there is a strong correlation between the feature value and the attribute data as a result of analysis by the relation analysis unit 120. The display unit 140 also displays a correlation value of the position. Furthermore, the display unit 140 displays the association rule generated by the rule generation unit 130.

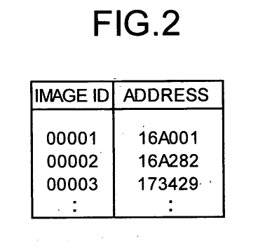

The image-data storage unit 150 stores image data from which a feature value is extracted. Here, the image-data storage unit 150 stores image data obtained by photographing the surface of the metal part of the machine at a fixed time interval. FIG. 2 is a table of image data stored in the image-data storage unit 150. The image data is stored by correlating an image identification (ID) for identifying individual images with an address of the image-data storage unit 150 that stores the body of the image data.

For example, data for an image with an image ID of “00001” indicates that the data is stored in an address of “16A001” of the image-data storage unit 150. Data for an image with an image ID of “00002” indicates that the data is stored in an address of “16A282” of the image-data storage unit 150.

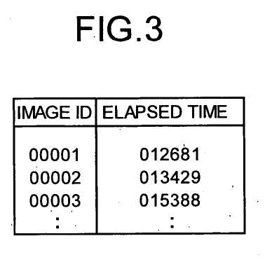

The attribute-data storage unit 160 stores attribute data used to analyze a relation with the feature value of the image. The attribute-data storage unit 160 stores, as attribute data, an elapsed time until a failure occurs in the metal part whose image is photographed. FIG. 3 is a table of the attribute data stored in the attribute-data storage unit 160. The attribute-data storage unit 160 stores image IDs that are in a one-to-one correspondence with elapsed times as attribute data.

For example, the image with the image ID of “00001” indicates that the failure occurs in the metal part after “012681” hours have passed since this image is photographed. The image with the image ID of “00002” indicates that the failure occurs in the metal part after “013429” hours have passed since this image is photographed.

The control unit 170 controls the whole of the knowledge discovery device 100. More specifically, the control unit 170 allows the knowledge discovery device 100 to function as a single device by transmitting and receiving controls between the processors and performing data transaction between each processor and each storage unit.

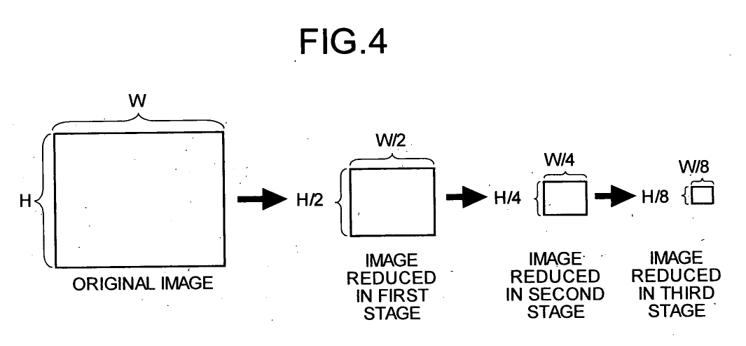

FIG. 4 is a schematic of to multiple resolution processing performed on image data by the feature-value extraction unit 110. The feature-value extraction unit 110 generates an image reduced from original image data in such a stepwise manner that each length of the height and the width of an image is reduced to a half, and subjects the image reduced to multiple resolution. Although reduction is carried out in three steps, the reduction may be performed in any number of steps.

The feature-value extraction unit 110 subjects each of the images reduced in the stages to wavelet transform using the Haar generating function. With this process, a degree of change in luminance in longitudinal, lateral, and oblique directions, each of which is at a position on the image, are obtained as feature values of the images reduced, respectively.

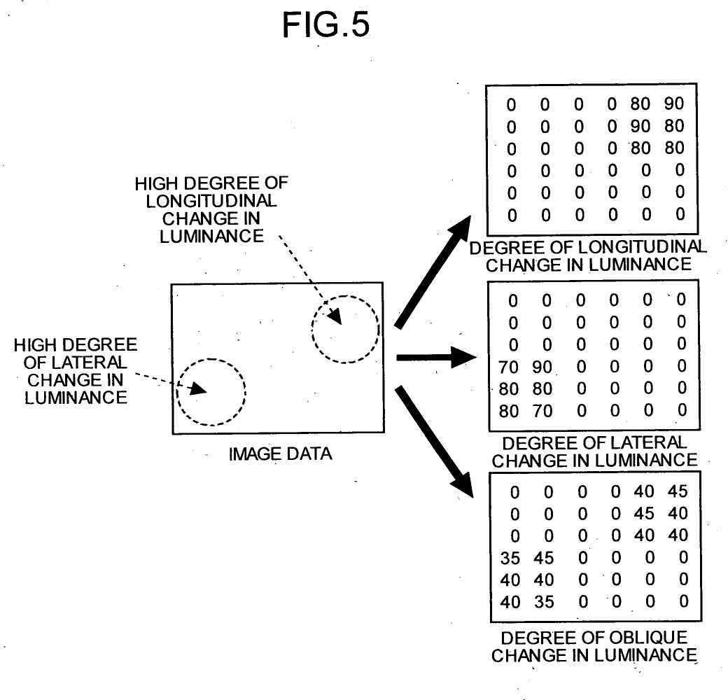

FIG. 5 is a schematic of wavelet transform performed on image data. By performing wavelet transform on the image data, a numerical alignment is obtained. The numerical alignment indicates the degree of change in luminance in longitudinal, lateral, and oblique directions.

As shown in FIG. 5, a target image data has an area with a high degree of change in luminance in a longitudinal direction in the upper right part thereof, and has an area with a high degree of change in luminance in a lateral direction in the lower left part thereof. Therefore, in the numerical alignment indicating the degree of change in luminance in a longitudinal direction, the numerical values corresponding to the upper right position on the image are large, while in the numerical alignment indicating the degree of change in luminance in a lateral direction, the numerical values corresponding to the lower left position on the image are large. In the numerical alignment indicating the degree of change in luminance in an oblique direction, the numerical values corresponding to the upper right position and the lower left position on the image are about middle.

The feature-value extraction unit 110 subjects the images reduced, which are generated in the stages, to wavelet transform in the above manner. The feature-value extraction unit 110 thereby obtains, as feature values, longitudinal, lateral, and oblique changes in luminance stepwisely in a range from a high-frequency component in a small range to a low-frequency component in a large range. In the small range, the change occurs finely, while in the large range, the change occurs gradually. In other words, the feature-value extraction unit 110 can extract a distribution pattern of pixel luminance in a particular area from the image data, as feature values.

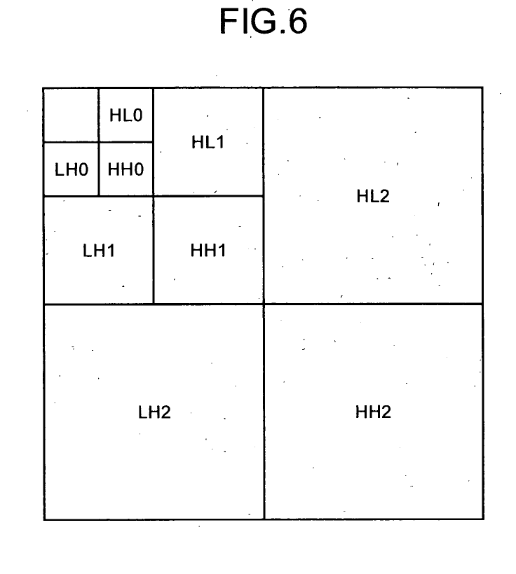

FIG. 6 is a schematic of a display of the result of wavelet transform. As shown in FIG. 6, a sign HL is an area indicating a degree of change in luminance in a lateral direction, LH is an area indicating a degree of change in luminance in a longitudinal direction, and HH is an area indicating a degree of change in luminance in an oblique direction. Numerical scripts indicate the stages of reduction, and a higher degree of reduction is expressed with a smaller number.

The feature-value extraction unit 110 extracts each degree of changes in luminance in longitudinal, lateral, and oblique directions of a plurality of frequency components, from the image data group stored in the image-data storage unit 150. The relation analysis unit 120 checks the numerical values indicating the degrees, and correlates a numerical value group at each position on the image with a numerical value group indicating the length of a time until a failure occurs, and calculates a correlation value between each two.

For example, the relation analysis unit 120 determines a correlation value Corr_{Txy} between a degree of change in luminance in a longitudinal direction (T) at a position (x, y) of an image reduced in an n-th stage of an i-th image data and an elapsed time until a failure occurs, using the following- equation (1). Where C_{Tnxyi} is a degree of change in luminance in the longitudinal direction (T) at the position (x, y) of the image reduced in the n-th stage of the i-th image data, and Tₗ is an elapsed time until the failure occurs that corresponds to the i-th image data.

$${Corr}_{Txy} = \frac{{\sum }_{i = 1}^{m} ( {C}_{Tnxyi} - \overline{{C}_{Tnxy}} ) ( {T}_{i} - \overline{T} )}{\sqrt{{\sum }_{i = 1}^{m} ( {C}_{Tnxyi} - \overline{{C}_{Tnxy}} ) {\sum }_{i = 1}^{m} ( {T}_{i} - \overline{T} )}} \qquad ( 1 )$$

m:Number of image data
:Average value, over all image data, of degree of change in luminance in the longitudinal direction (T) at position (x, y) of an image reduced in the n-th stage
\overline{T}: Average value of total elapsed time

A range of a correlation value calculated by the equation (1) is [−1.0, 1.0]. A larger value indicates a stronger positive correlation, and a smaller value indicates a stronger negative correlation. Therefore, if there is a strong negative correlation between a degree of change (feature value) in luminance of a certain frequency component in a certain direction at a position on the image and an elapsed time (attribute data) until a failure occurs, and if the degree of change in luminance is high, the elapsed time may be short. In this case, there is a higher possibility of occurrence of the failure within a short period of time.

The relation analysis unit 120 calculates, in the above manner, each correlation value between each degree of longitudinal, lateral, and oblique changes in luminance of frequency components at positions on the image and each elapsed time until the failure occurs. It is thereby possible to discover a knowledge on a relation between a luminance distribution pattern in a particular area on the surface of a metal part and a possibility of occurrence of the failure in the metal part.

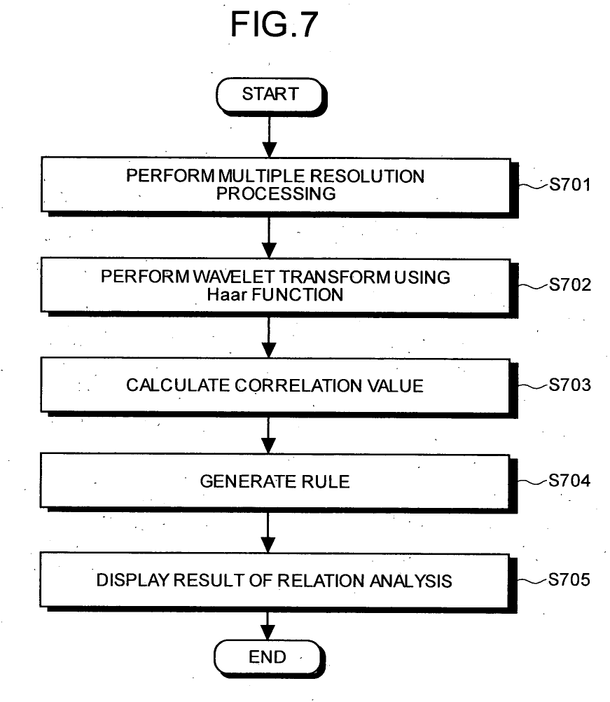

FIG. 7 is a flowchart of the process of the knowledge discovery device 100 according to the first embodiment. In the knowledge discovery device 100,the feature-value extraction unit 110 subjects the image data group stored in the image-data storage unit 150 to multiple resolution (step S701), and subjects each image obtained through multiple resolution to wavelet transform using the Haar generating function (step S702).

More specifically, the feature-value extraction unit 110 calculates, as a feature value, each degree of longitudinal, lateral, and oblique changes in luminance of frequency components at positions on the image for all the image data stored in the image-data storage unit 150.

As for numerical values indicating the degrees of changes in luminance in longitudinal, lateral, and oblique directions of the frequency components extracted by the feature-value extraction unit 110, the relation analysis unit 120 correlates a numerical value group at each position on the image with a numerical value group indicating a length of a time until a failure occurs, and calculates each correlation value (step S703).

The rule generation unit 130 generates an association rule using content of the feature value such that a correlation value having a predetermined correlation value (e.g., −0.7) or less is calculated and content of the attribute data (step S704). More specifically, the content of the feature value is a degree of change in luminance of a certain frequency component in a certain direction at a position on the image, and the content of the attribute data is a length of a time until the failure occurs.

The display unit 140 displays the frequency components such that the correlation value having the predetermined correlation value (e.g., −0.7) or less is calculated, the direction of change in luminance and the position on the image, and the association rule generated by the rule generation unit 130 (step S705).

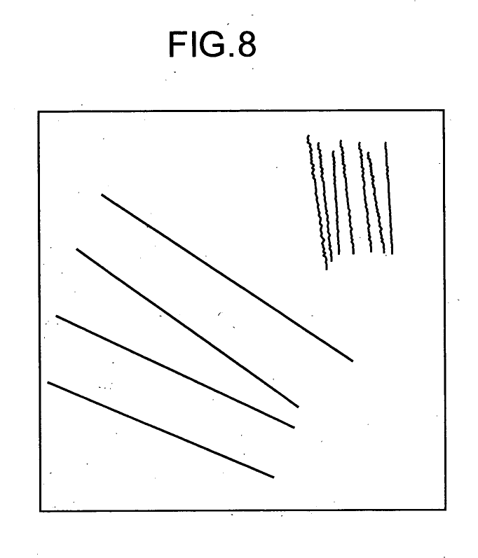

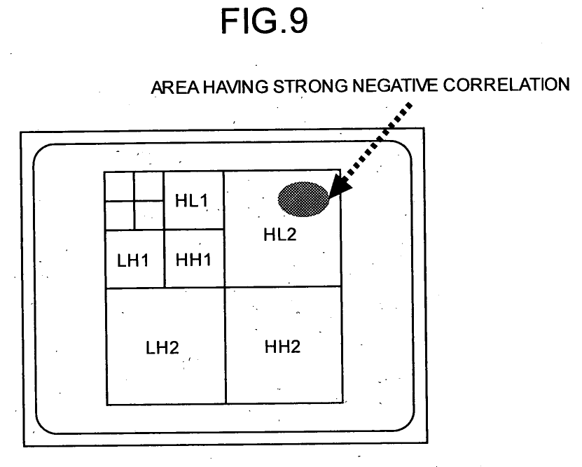

FIG. 8 is a schematic of an image obtained by photographing the surface of a metal part of a machine. FIG. 9 is a schematic of a display for a knowledge discovered by the knowledge discovery device 100 from the image shown in FIG. 8.

In the image shown in FIG. 8, there are fine cracks like vertical stripes in the upper right part on the surface of the metal part and slanting cracks at wide intervals in the left lower half. As a result of processing the image data in the knowledge discovery device 100, it is found that there is a strong negative correlation between the content of the feature value and the content of the attribute data. The content of the feature value is such that the degree of lateral change in high-frequency luminance in the upper right part of the image is high, and the content of the attribute data is such that the elapsed time is short.

As shown in FIG. 9, the knowledge discovery device 100 displays, as a knowledge discovered, an area where there is a strong negative correlation between the upper right part of an HL area in the stage where reduction is in the smallest level and the elapsed time until the failure occurs. The HL area is an area indicating a degree of change in luminance in a lateral direction in high-frequency.

In the first embodiment, as explained above, the feature-value extraction unit 110 extracts, as a feature value, each degree of changes in luminance in longitudinal, lateral, and oblique directions of the frequency components at each position on an image, from the image data on the surface of the metal part, using the wavelet transform. The relation analysis unit 120 calculates a correlation value between attribute data and the feature value, the attribute data being an elapsed time until a failure occurs in the metal part. The rule generation unit 130 generates an association rule using the content of the feature value with a correlation value having a predetermined correlation value (e.g., −0.7) or less and using the content of the attribute data. Therefore, a knowledge can be discovered even from an image such that the feature indicating occurrence of a failure is shown in a luminance distribution pattern of a particular area, like the image of the surface of the metal part.

In the first embodiment, the case where the image data is, subjected to multiple resolution and the feature is extracted from the multiple-resolution image using the wavelet transform is explained. However, the multiple resolution of the image data and the extraction of the feature from the multiple-resolution image can also be performed using a method other than the wavelet transform. Another method of subjecting image data to multiple resolution and extracting a feature from the multiple-resolution image is explained in a second embodiment of the present invention.

In the second embodiment, a case where a relation between a color feature of a package of and a position of an item in a shelf and its sales is discovered as an association rule is explained. More specifically, the relation is discovered from data for an image obtained by photographing a state of shelf allocation of items in retail stores such as convenience stores and from sales data for the items.

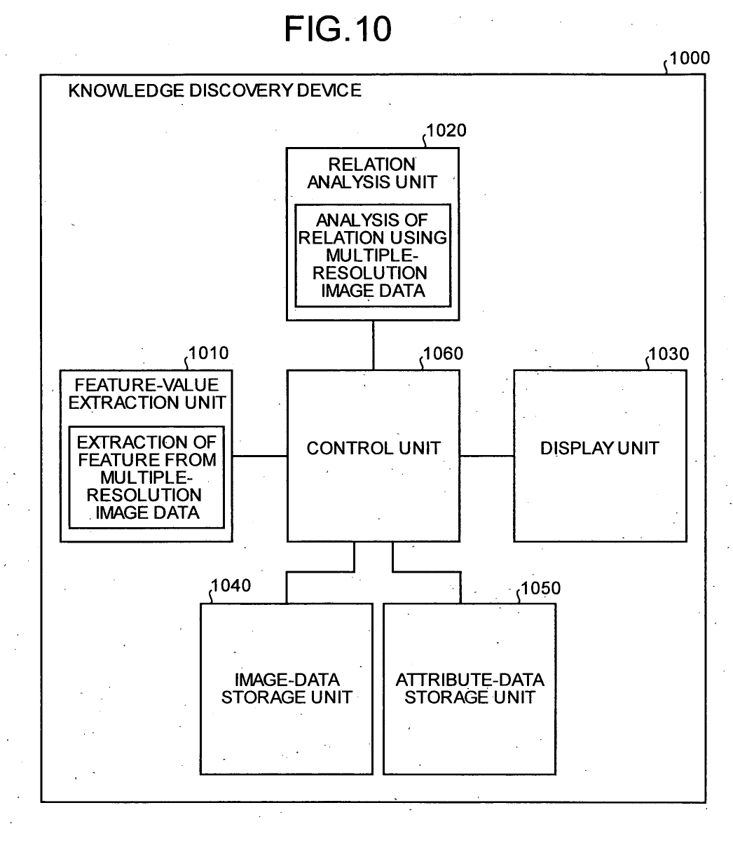

FIG. 10 is a block diagram of a knowledge discovery device according to the second embodiment. A knowledge discovery device 1000 includes a feature-value extraction unit 1010 that extracts a feature value, a relation analysis unit 1020 that analyzes a relation between a feature value and attribute data, and a display unit 1030 that displays the result of analysis. The knowledge discovery device 1000 also includes an image-data storage unit 1040 that stores data for images obtained by photographing various patterns of shelf allocations due to different ways of shelf allocations and different items exhibited. The knowledge discovery device 1000 also includes an attribute-data storage unit 1050 that stores sales data in a one-to-one correspondence with positions on an image for each display item, and a control unit 1060 that controls the whole.

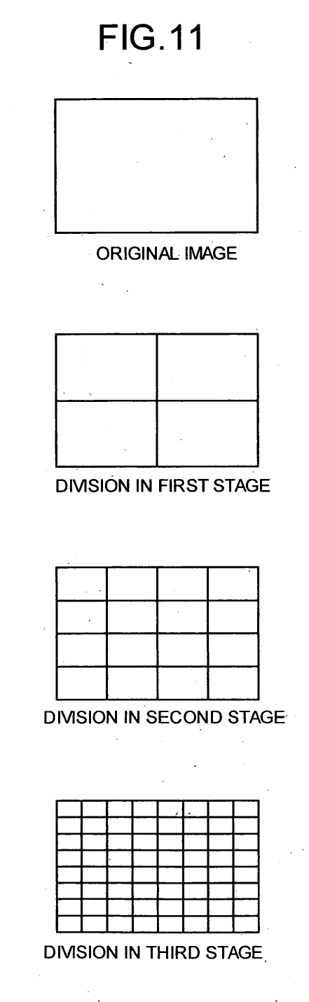

FIG. 11 is a schematic of multiple resolution processing performed on image data by the feature-value extraction unit 1010 shown in FIG. 10. The feature-value extraction unit 1010, divides the height and the width of an image into a half to obtain four images and continues the division in stages, and calculates, as a feature value, an average value of pixel color of each of the images obtained through the divisions in the stages.

The relation analysis unit 1020 correlates an average value group of color calculated as the feature value by the feature-value extraction unit 1010 with a numerical value group of sales data for each division area in division stages. If the conclusion part is such that sales not less than a predetermined sales value are accomplished, then the relation analysis unit 1020 generates an association rule that satisfies given support and confidence, using a data mining technique.

A term “support” mentioned here indicates a proportion of data related to the association rule generated, and a term “confidence” indicates a level of confidence in the association rule generated.

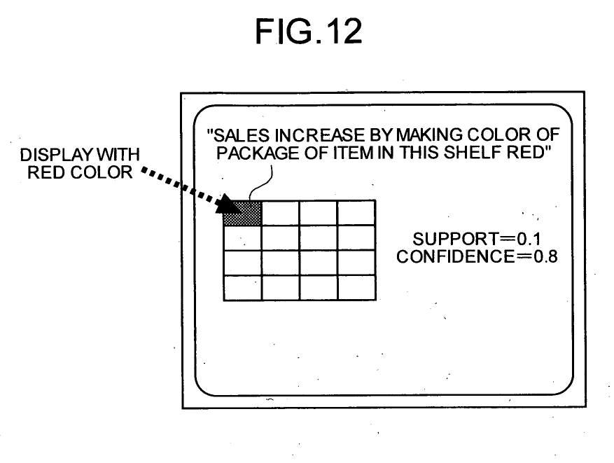

As a result, an association rule is obtained in the following manner. The condition part of the association rule is such that the upper left area of the division in the second stage of FIG. 11 is provided with a color, generally felt as a red color, in a range based on Red, Green, and Blue (RGB) values. In the range, the R value is from “250” to “255”, the G value from “0” to “10”, and the B value from “0” to “5” (the range of the R, G, and B values is in [0, 255]). In this case, as shown in FIG. 12, the display unit 1030 displays a corresponding position on an image with a red color. Furthermore, the display unit 1030 provides the association rule obtained as the result of analysis together with the support and the confidence to a user.

The knowledge discovery device 1000 can provide a knowledge as explained below that is obtained in the above manner to the user. The knowledge is such that sales increase by making a color of a package of an item “red color”. The item is exhibited on a position of a shelf corresponding to the area on the image displayed with the red color.

In the second embodiment, as explained above, the feature-value extraction unit 1010 divides the height and the width of an image into a half to obtain four images and continues the division in stages, and calculates, as a feature value, an average value of pixel color for each of the images obtained through the divisions in the stages. The relation analysis unit 1020 correlates an average value group of color with a numerical value group of sales data in each division area, and generates an association rule using the data mining technique. Therefore, it is possible to discover a knowledge on a relation between the feature value and the attribute data, even from an image such that a location and a size of a feature are indefinite like the image of shelf allocation of items.

In the first embodiment and the second embodiment, the knowledge discovery devices are explained. However, by realizing the configurations included in the knowledge discovery devices with software, it is possible to obtain a knowledge discovery program having the same function as explained above.

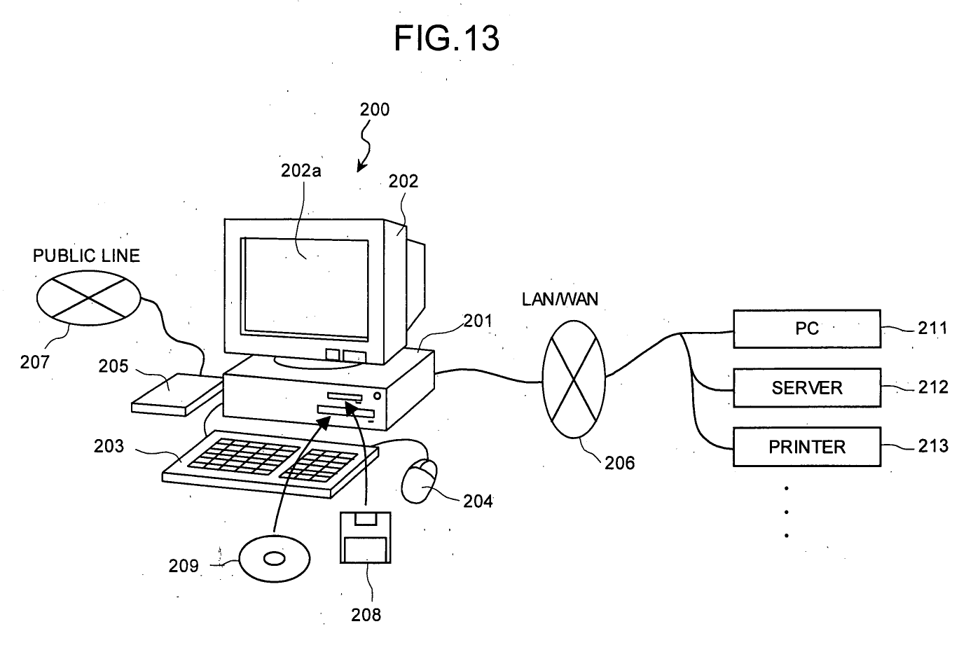

FIG. 13 is a diagram of a computer system for executing a knowledge discovery program according to the embodiments. A computer system 200 includes a main body 201, a display 202 that displays information on a display screen 202a according to an instruction from the main body 201, a keyboard 203 for entering various pieces of information into the computer system 200, a mouse 204 for specifying an arbitrary position on the display screen 202a, a local area network (LAN) interface connecting to LAN 206 or a wide area network (WAN), and a modem 205 connecting to a public line 207 such as the Internet. The LAN 206 connects the computer system 200 to another computer system (PC) 211, a server 212, and a printer 213, and so on.

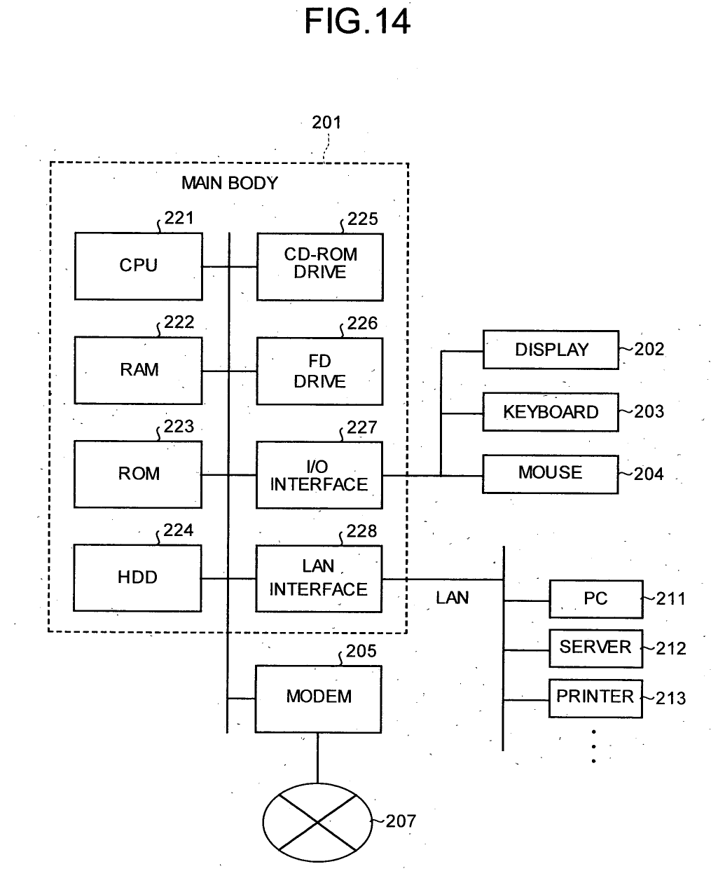

FIG. 14 is a block diagram of the main body 201 of FIG. 13. The main body 201 includes a central processing unit (CPU) 221, a random access memory (RAM) 222, a read only memory (ROM) 223, a hard disk drive (HDD) 224, a compact disk (CD)-ROM drive 225, a floppy disk (FD) drive 226, an input/output (I/O) interface 227, and a LAN interface 228.

The knowledge discovery program executed in the computer system 200 is stored in a portable type recording medium such as a floppy disk (FD) 208, a CD-ROM 209, a digital versatile disk (DVD), a magneto-optical disk, and an integrated circuit (IC) card. The knowledge discovery program is read out from any one of these recording media and installed into the computer system 200.

Alternatively, the knowledge discovery program is stored in a database such as a database of the server 212 connected to the main body 201 through the LAN interface 228, a database of the computer system (PC) 211 connected thereto, and a database of another computer system connected thereto through the public line 207. The knowledge discovery program is then read out from any one of these databases and installed into the computer system 200.

The knowledge discovery program installed is stored in the HDD 224, and is executed by the CPU 221 using the RAM 222 and the ROM 223.

As explained above, according to the present invention, image data that is subjected to multiple resolution is generated from each image data, a feature value is extracted from the image data subjected to multiple resolution, and a relation between the feature value extracted and attribute data is analyzed. Therefore, it is possible to discover a knowledge even from an image such that a feature is present in a distribution pattern of pixel values in a local area and even from an image such that a position and a size of a feature are indefinite.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A knowledge discovery device that analyzes a relation between a feature value in an image and attribute data using a plurality of pairs of image data and attribute data that is correlated to the image data, and that discovers a knowledge on the relation, the knowledge discovery device comprising:
a feature-value extraction unit that generates multiple-resolution image data from each of the image data, and that extracts a feature value from the multiple-resolution image data; and
a relation analysis unit that analyzes a relation between the feature value and the attribute data.

2. The knowledge discovery device according to claim 1, further comprising a rule generation unit that generates, based on a result of analysis by the relation analysis unit, either one of an association rule in which content of the feature value is set as a condition part and content of the attribute data is set as a conclusion part, and an association rule in which content of the attribute data is set as a condition part and content of the feature value is set as a conclusion part.

3. The knowledge discovery device according to claim 1, further comprising a result display unit, wherein
the feature-value extraction unit extracts a feature value corresponding to a position on the image from the multiple-resolution image data,
the relation analysis unit calculates a value of a correlation between the feature value corresponding to the position and the attribute data, and
the result display unit displays the value and the position that corresponds to the value within a predetermined range as a result of analysis.

4. The knowledge discovery device according to claim 3, wherein
the feature-value extraction unit extracts, as a feature value, each degree of changes in luminance of a plurality of frequency components in a longitudinal, lateral, and oblique directions at each position on the image, from the multiple-resolution image data, using wavelet transform.

5. The knowledge discovery device according to claim 1, wherein
the feature-value extraction unit generates the multiple-resolution image data by dividing the image in longitudinal and lateral directions in stages, and uses an average value of color of image data corresponding to each of the images obtained at each stage as the feature value.

6. The knowledge discovery device according to claim 1, wherein
the relation analysis unit analyzes a relation between the feature value and the attribute data using a data mining technique.

7. A knowledge discovery method for analyzing a relation between a feature value in an image and attribute data using a plurality of pairs of image data and attribute data that is correlated to the image data, and for discovering a knowledge on the relation, the knowledge discovery method comprising:
generating multiple-resolution image data from each of the image data;
extracting a feature value from the multiple-resolution image data; and
analyzing a relation between the feature value and the attribute data.

8. The knowledge discovery method according to claim 7, further comprising generating, based on a result of analysis by the relation analysis unit, either one of an association rule in which content of the feature value is set as a condition part and content of the attribute data is set as a conclusion part, and an association rule in which content of the attribute data is set as a condition part and content of the feature value is set as a conclusion part.

9. The knowledge discovery method according to claim 7, further comprising displaying a result, wherein
the extracting includes extracting a feature value corresponding to a position on the image from the multiple-resolution image data,
the analyzing includes calculating a value of a correlation between the feature value corresponding to the position and the attribute data, and
the displaying includes displaying the value and the position that corresponds to the value within a predetermined range as a result of analysis.

10. The knowledge discovery method according to claim 9, wherein
the extracting includes extracting, as a feature value, each degree of changes in luminance of a plurality of frequency components in a longitudinal, lateral, and oblique directions at each position on the image, from the multiple-resolution image data, using wavelet transform.

11. The knowledge discovery method according to claim 7, wherein
the generating includes generating the multiple-resolution image data by dividing the image in longitudinal and lateral directions in stages, and using an average value of color of image data corresponding to each of the images obtained at each stage as the feature value.

12. The knowledge discovery method according to claim 7, wherein
the analyzing includes analyzing a relation between the feature value and the attribute data using a data mining technique.

13. A computer-readable recording medium that stores a computer program for realizing a knowledge discovery method for analyzing a relation between a feature value in an image and attribute data using a plurality of pairs of image data and attribute data that is correlated to the image data, and for discovering a knowledge on the relation on a computer, the computer program making the computer execute:
generating multiple-resolution image data from each of the image data;
extracting a feature value from the multiple-resolution image data; and
analyzing a relation between the feature value and the attribute data.

14. The computer-readable recording medium according to claim 13, wherein
the computer program further makes the computer execute generating, based on a result of analysis by the relation analysis unit, either one of an association rule in which content of the feature value is set as a condition part and content of the attribute data is set as a conclusion part, and an association rule in which content of the attribute data is set as a condition part and content of the feature value is set as a conclusion part.

15. The computer-readable recording medium according to claim 13, wherein
the computer program further makes the computer execute displaying a result,
the extracting includes extracting a feature value corresponding to a position on the image from the multiple-resolution image data,
the analyzing includes calculating a value of a correlation between the feature value corresponding to the position and the attribute data, and
the displaying includes displaying the value and the position that corresponds to the value within a predetermined range as a result of analysis.

16. The computer-readable recording medium according to claim 15 wherein
the extracting includes extracting, as a feature value, each degree of changes in luminance of a plurality of frequency components in a longitudinal, lateral, and oblique directions at each position on the image, from the multiple-resolution image data, using wavelet transform.

17. The computer-readable recording medium according to claim 13, wherein
the generating includes generating the multiple-resolution image data by dividing the image in longitudinal and lateral directions in stages, and using an average value of color of image data corresponding to each of the images obtained at each stage as the feature value.

18. The computer-readable recording medium according to claim 13, wherein
the analyzing includes analyzing a relation between the feature value and the attribute data using a data mining technique.
